(19) United States
(12) Patent Application Publication
(10) Pub. No.: US 2026/0119914 A1
(43) Pub. Date: Apr. 30, 2026

(54) CROSS-AGENT KNOWLEDGE TRANSFER

(71) Applicant: BOOMI, LP, Conshohocken, PA (US)

(72) Inventors: Ayush PARASHAR, Foster City, CA (US); Lomesh AGRAWAL, Bangalore (IN); Swagata ASHWANI, San Francisco, CA (US); Kashif MOHAMMAD, Nagpur (IN)

(73) Assignee: BOOMI, LP, Conshohocken, PA (US)

(21) Appl. No.: 19/364,260

(22) Filed: Oct. 21, 2025

(30) Foreign Application Priority Data
Oct. 25, 2024 (IN) 202411081537
Oct. 25, 2024 (IN) 202411081538

(51) Int. Cl. G06N 5/022

(52) U.S. Cl. CPC G06N 5/022

(57) ABSTRACT

Typically, in order to preserve their specializations, AI agents operate with isolated knowledge bases to learn skills independently from other AI agents. This results in a waste of computational resources and reduces the adaptability of the AI agents and overall system. Accordingly, disclosed embodiments enable AI agents to learn from each other, while retaining their specialized capabilities. A knowledge manager may identify knowledge elements, within a knowledge repository, that are compatible with a receiving AI agent and do not diminish the specialization of the receiving AI agent. An incremental transfer process may be executed, with performance monitoring and rollback capabilities, to incorporate the knowledge elements into the receiving AI agent, while ensuring that the knowledge transfer does not diminish the specialization of the receiving AI agent. A cross-agent collaboration interface is also disclosed for knowledge sharing and collaboration between AI agents.

### CROSS-REFERENCE TO RELATED APPLICATIONS

The present application claims priority to Indian Patent Application number 202411081537, filed on Oct. 25, 2024, and Indian Patent Application number 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to knowledge transfer between AI agents.

### Description of the Related Art

A number of platforms exist that enable users to construct artificial intelligence (AI) agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

Typically, AI agents operate with isolated knowledge bases. This results in knowledge silos, which are used by AI agents to learn skills independently from other AI agents. While isolation enables the specialization of AI agents, it prevents an AI agent from benefitting from the experience of another AI agent. This results in redundant learning, which wastes computational resources (e.g., in terms of processing, memory, data storage, communications, etc.), otherwise prevents the efficient utilization of available computational resources, and reduces the adaptability of the AI agents and the overall system. Thus, traditionally, a choice must be made between keeping AI agents isolated to enable specialization, or risk undermining specialization through indiscriminate knowledge sharing.

### SUMMARY

Accordingly, systems, methods, and non-transitory computer-readable media are disclosed for knowledge transfer between AI agents, which ensures retained specialization of the receiving AI agents.

In an embodiment, a method comprises using at least one hardware processor to, for each of one or more receiving artificial intelligence (AI) agents: receive data representing the receiving AI agent; identify one or more compatible knowledge elements, which are compatible with the receiving AI agent, and which are associated in a knowledge repository with one or more source AI agents that match the receiving AI agent, based on the received data; generate a transfer process that incorporates each of the one or more compatible knowledge elements into an architecture of the receiving AI agent over a time span; and execute the transfer process to incorporate each of the one or more compatible knowledge elements into the architecture of the receiving AI agent over the time span.

The one or more compatible knowledge elements may comprise a first knowledge element and a second knowledge element, wherein executing the transfer process comprises, during the time span: incorporating the first knowledge element into the receiving AI agent at a first time within the time span; and incorporating the second knowledge element into the receiving AI agent at a second time, within the time span, that is subsequent to the first time.

The method may further comprise using the at least one hardware processor to, for each of the one or more receiving AI agents: collect one or more prior performance metrics for the receiving AI agent before the execution of the transfer process; collect one or more subsequent performance metrics for the receiving AI agent after the execution of the transfer process; and determine a change in performance of the receiving AI agent based on a difference between the one or more prior performance metrics and the one or more subsequent performance metrics.

The one or more compatible knowledge elements may comprise a first knowledge element and a second knowledge element, wherein the method further comprises, for each of the one or more receiving AI agents, collecting one or more prior performance metrics for the receiving AI agent before the execution of the transfer process, and wherein executing the transfer process comprises, during the time span: incorporating the first knowledge element into the receiving AI agent at a first time within the time span; collecting one or more subsequent performance metrics for the receiving AI agent after the first time; determining a change in performance of the receiving AI agent based on a difference between the one or more prior performance metrics and the one or more subsequent performance metrics; when the change in performance is positive, incorporating the second knowledge element into the receiving AI agent at a second time, within the time span, that is subsequent to the first time; and when the change in performance is negative, rolling back the incorporation of the first knowledge element into the receiving AI agent.

Each of the one or more compatible knowledge elements may comprise one or more of a learned behavior, acquired skill, agentic configuration, identifier of an AI model, identifier of a tool, an instruction, a chain of reasoning, an objective, an input format, an output format, or an identifier of a knowledge base.

Identifying the one or more compatible knowledge elements may comprise: identifying a plurality of source AI agents that matches the receiving AI agent; extracting a plurality of knowledge elements that are associated with the identified plurality of source AI agents within the knowledge repository; generating a compatibility score for each of the plurality of knowledge elements; and identifying the one or more compatible knowledge elements, from the plurality of knowledge elements, based on the generated compatibility scores for the plurality of knowledge elements. The compatibility score for each of the plurality of knowledge elements may be based on one or more of an architectural similarity between the receiving AI agent and one of the identified plurality of source AI agents with which the knowledge element is associated, a domain of the one of the identified plurality of source AI agents with which the knowledge element is associated, or a complementarity of a function of the one of the identified plurality of source AI agents with which the knowledge element is associated to a function of the receiving AI agent.

The method may further comprise using the at least one hardware processor to, by a first AI agent: utilize a cross-agent collaboration interface, between the first AI agent and a second AI agent, to request a capability from the second AI agent, according to a knowledge-request protocol; receive at least one knowledge element, representing the requested capability, from the second AI agent; and incorporate the at least one knowledge element into an architecture of the first AI agent. The method may further comprise using the at least one hardware processor to, by the first AI agent, store a relationship between the at least one knowledge element and the second AI agent. The relationship may be a child relationship and be stored within a local memory of the first AI agent. The knowledge-request protocol may be a peer-to-peer protocol, such that the first AI agent requests the capability directly from the second AI agent and receives the at least one knowledge element directly from the second AI agent.

The method may further comprise using the at least one hardware processor to, for each of the one or more receiving AI agents, for each of the one or more compatible knowledge elements, transform the compatible knowledge element into a format used by the architecture of the receiving AI agent.

Identifying the one or more compatible knowledge elements may comprise: matching the one or more source AI agents to the receiving AI agent based on a semantic similarity metric; and retrieving one or more knowledge elements associated with at least one of the matching one or more source AI agents. Identifying the one or more compatible knowledge elements may further comprise, for each of at least a subset of the retrieved one or more knowledge elements: generating a compatibility score for that retrieved knowledge element; and determining whether or not to include the retrieved knowledge element in the one or more compatible knowledge elements based on the compatibility score. Identifying the one or more compatible knowledge elements may further comprise, for each of at least a subset of the retrieved one or more knowledge elements: determining whether or not that retrieved knowledge element conflicts with a component element of the receiving AI agent; and when determining that the retrieved knowledge element conflicts with the component element of the receiving AI agent, excluding the retrieved knowledge element from the one or more compatible knowledge elements.

The transfer process may include one or more isolation protocols that prevent the one or more compatible knowledge elements from interacting with one or more component elements of the receiving AI agent.

The method may further comprise using the at least one hardware processor to: identify one or more high-performing AI agents; and for each of the one or more high-performing AI agents, extract one or more knowledge elements from the high-performing AI agent, and add the one or more knowledge elements to the knowledge repository. The method may further comprise using the at least one hardware processor to, for each of the one or more high-performing AI agents, for each of the one or more knowledge elements extracted from the high-performing AI agent: classify the knowledge element into a classification in each of a plurality of dimensions; and add the classifications in the plurality of dimensions to metadata associated with the knowledge element within the knowledge repository.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for knowledge transfer between artificial intelligence (AI) agents, according to an embodiment; and

FIG. 4 illustrates an example process for knowledge transfer between AI agents, according to an embodiment.

### DETAILED DESCRIPTION

Embodiments of systems, methods, and non-transitory computer-readable media are disclosed for knowledge transfer between AI agents. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

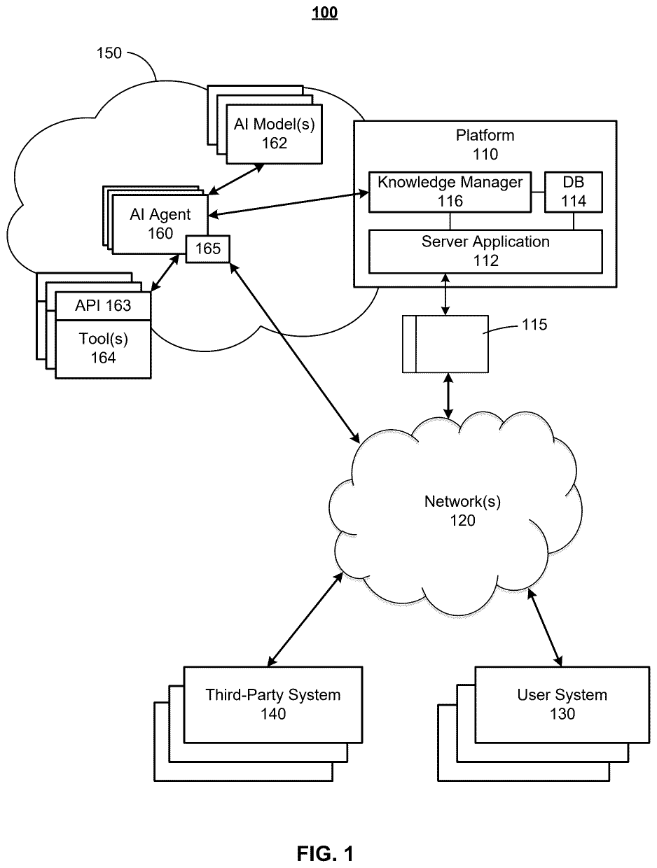

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or a knowledge manager 116. Platform 110 may also host a database 114 that may store data used and/or produced by server application 112 and/or knowledge manager 116. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a manager or developer of artificial intelligence (AI) agents 160, who has a user account for accessing server application 112 on platform 110. It should be understood that the user may be anywhere from an expert software engineer, with extensive knowledge of AI agents, to a business decision-maker, lay person, or other non-technical person, with little to no knowledge of AI agents. Each user account may be associated with an overarching organizational account for managing software entities, including AI agents 160.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112 in accordance with roles or permissions of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each AI agent 160 and/or integration process, when deployed, may be communicatively coupled to network(s) 120. For example, each AI agent 160 and/or integration process may comprise an application programming interface that enables clients to access the software entity via network(s) 120. For instance, AI agent 160 comprises an agentic interface 165 that may comprise or consist of an application programming interface. A client may push data to an AI agent 160 and/or integration process through the application programming interface, and/or pull data from AI agent 160 and/or an integration process through the application programming interface.

In some cases, an AI agent 160 may be a conversational AI agent. In this case, AI agent 160 may implement a chat interface, within agentic interface 165. The chat interface may be comprised or embedded (e.g., as an overlaid chat frame) within user interface 115. Alternatively, the chat interface may be separate and distinct from user interface 115. The chat interface may comprise a graphical user interface, an audio interface, or a combination of graphical and audio user interface (i.e., an audiovisual interface).

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

As discussed above, the software entities(s) being developed and/or otherwise managed on platform 110 may include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like. Although only a few AI agents 160 are illustrated, it should be understood that computing environment 150 may comprise any number of AI agents 160, including hundreds, thousands, tens of thousands, hundreds of thousands, millions, tens of millions, hundreds of millions, billions, tens of billions, hundreds of billions, or more AI agents 160. For the sake of simplicity, an AI agent 160 may also be referred to herein simply as an “agent,” and the term “agentic” is an adjective that indicates that the subsequent noun pertains to an AI agent 160.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to herein as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

### 2. Example Processing System

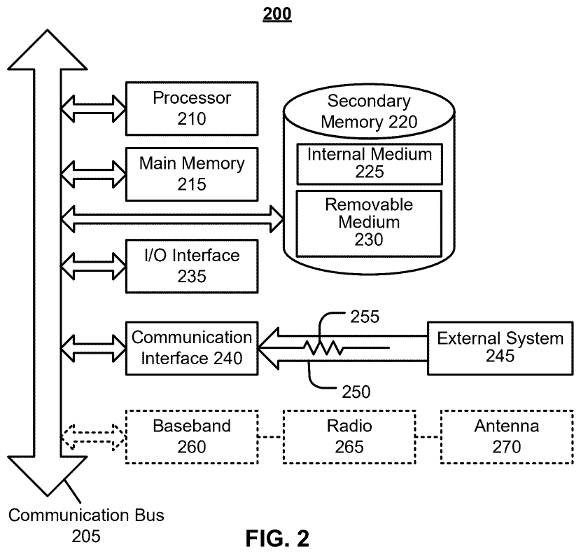

FIG. 2 illustrates an example processing system 200, by which one or more of the processes described herein may be executed, according to an embodiment. For example, system 200 may be used to store and/or execute server application 112, knowledge manager 116, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Overall Process

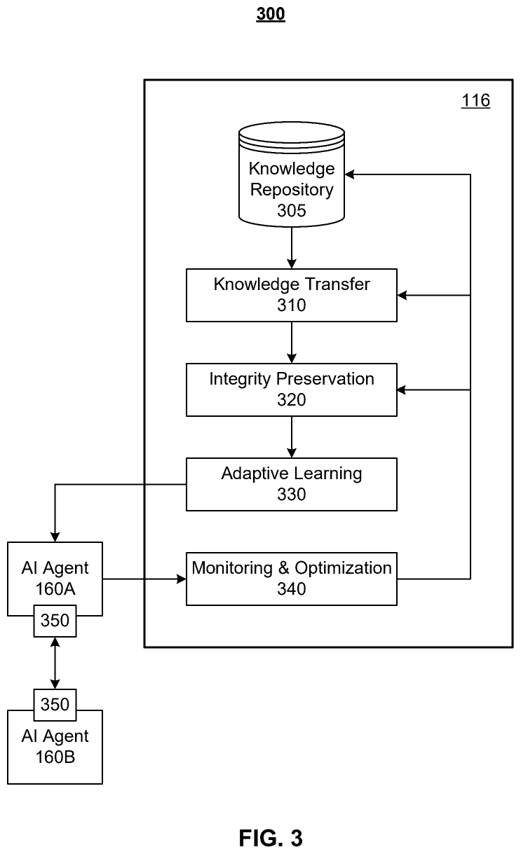

FIG. 3 illustrates an example data flow 300 for knowledge transfer between AI agents 160, according to an embodiment. The bulk of data flow 300 may be implemented by knowledge manager 116. Knowledge manager 116 may be a software module of server application 112, or may be a software entity that is separate from server application 112, but which may be communicatively coupled to server application 112. As an example of the latter, knowledge manager 116 may itself be an AI agent 160, which utilizes one or more AI models 162 and/or tools 164 to perform or aid in the disclosed functions. In any case, knowledge manager 116 may comprise or be communicatively coupled to an AI model, such as a large language model, to be used by one or more of its component modules. As illustrated, knowledge manager 116 may comprise or be communicatively coupled to a knowledge repository 305 (e.g., stored within database 114). Knowledge manager may comprise a knowledge-transfer module 310, integrity-preservation module 320, adaptive-learning module 330, and monitoring-and-optimization module 340.

Knowledge repository 305 is a centralized repository for a plurality of knowledge elements from a plurality of source AI agents 160, executing within computing environment 150. Each knowledge element is one unit of transferrable knowledge. A knowledge element may comprise a learned behavior, an acquired skill, an agentic configuration (e.g., comprising the value of each of one or more configurable parameters), an identifier of an AI model 162, an identifier of a tool 164 or set of tools 164, an instruction or set of instructions, a chain of reasoning, an objective, input format and/or output format, an identifier of a knowledge base, and/or the like. Each knowledge element in knowledge repository 305 may be extracted from an existing AI agent 160 within computing environment 150.

In an embodiment, knowledge repository 305 only comprises knowledge elements from a trusted subset of AI agents 160 within computing environment 150. In other words, only the trusted subset of AI agents 160 is able to contribute knowledge elements to knowledge repository 305. Ideally, this subset only consists of AI agents 160 with a lengthy history of successful execution (e.g., as determined by positive user feedback, performance metrics, etc.). In this case, the knowledge elements in repository 305 represent knowledge from successful, high-performing AI agents 160. Such knowledge elements represent good candidates for being transferred to new AI agents 160.

Selection of AI agents 160 to be included in the trusted subset of AI agents 160, which contribute to knowledge repository 305, may be determined based on one or more factors. These factor(s) may include, without limitation, the performance of AI agents 160 (e.g., with AI agents 160 having better performance metrics being trusted more than AI agents 160 with worse performance metrics), usage (e.g., as an amount of time in operation, one or more utilization metrics, such as number of utilizations, the reputations of utilizing organizations, etc.) of AI agents 160 (e.g., with AI agents 160 having higher usage being trusted more than AI agents 160 having shorter usage), the feedback (e.g., user feedback) for AI agents 160 (e.g., with AI agents 160 having more positive feedback being trusted more than AI agents 160 having less positive or more negative feedback), the developers of AI agents 160 (e.g., with certain developers' AI agents 160 being trusted more than other developers' AI agents 160), the AI models 162 and/or tools 164 utilized by AI agents 160 (e.g., with certain AI models 162 and/or tools 164 being trusted more than other AI models 162 and/or tools 164), and/or the like.

Each knowledge element in knowledge repository 305 may be associated with metadata. The metadata may comprise one or more tags for the knowledge element, one or more performance metrics for the knowledge element, one or more usage statistics for the knowledge element, contextual information about the knowledge element (e.g., contextual dependencies of the knowledge element), an identifier of the AI agent 160 from which the knowledge element was collected, and/or the like. The tag(s) for a knowledge element may be generated at the time that the knowledge element is added to knowledge repository 305. The performance metric(s) and/or usage statistic(s) may be collected, over time, by monitoring-and-optimization module 340, as discussed elsewhere herein, while the respective AI agent 160, from which the knowledge element was extracted, operates within a production environment or test environment within computing environment 150.

Whenever a new knowledge element is added to knowledge repository 305, the knowledge element may be tagged with one or more classifications. In other words, tags, representing the classification(s), may be added to the metadata of the knowledge element. In particular, one or more classifiers may be applied to the knowledge element to generate classifications of the knowledge element, across one or more dimensions, that are then associated with the knowledge element within knowledge repository 305. For example, the new knowledge element and/or one or more features derived from the new knowledge element may be input to each of one or more classifiers, and each classifier may output one classification, from among a plurality of possible classifications (e.g., discrete or continuous values), of the new knowledge element in one of one or more dimensions. In an embodiment, a plurality of classifiers are used to produce classifications of the new knowledge element across a plurality of dimensions. The plurality of dimensions may include the function of the new knowledge element, the domain (e.g., healthcare, customer service, etc.) of the new knowledge element, the reliability of the new knowledge element (e.g., as a numerical score), a compatibility of the new knowledge element, and/or the like. Each classifier may comprise rule-based logic, a machine-learning model (e.g., artificial neural network), a generative language model (e.g., large language model or small language model), and/or the like. As mentioned above, each tag may be incorporated into the metadata for the respective knowledge element.

Knowledge repository 305 may implement version control for each knowledge element. For example, when knowledge repository 305 has an existing version of a new knowledge element from the same AI agent 160, knowledge repository 305 may store the new knowledge element as a new version of the existing knowledge element. In particular, each knowledge element may be associated with a version number, and a new version number may be associated with each new version of that knowledge element from the same AI agent 160, according to any suitable version numbering scheme (e.g., incremental with major and minor version numbers). Thus, every version of each stored knowledge element for each source AI agent 160 may be stored within knowledge repository 305. This enables analysis of how each knowledge element has evolved over time, and enables an AI agent 160 to access prior versions of stored knowledge elements, for example, in the event that a rollback to a prior version of a knowledge element is required.

At a high level, knowledge-transfer module 310 may receive data representing an AI agent 160A of interest and extract knowledge elements, from knowledge elements within knowledge repository 305, that may be incorporated into AI agent 160A via a transfer process. AI agent 160A may be a new AI agent 160 that is in the process of being designed or about to be deployed. Alternatively, AI agent 160A may be a deployed AI agent 160 that is currently executing within a production environment or test environment within computing environment 150. The received data about AI agent 160A, used by knowledge-transfer module 310, may comprise the specification of AI agent 160A, which may identify AI model(s) 162 used by AI agent 160A, tool(s) 164 used by AI agent 160A, instruction(s) used by AI agent 160A, a chain of reasoning employed by AI agent 160A, input format and/or output format of AI agent 160A, an identifier of a knowledge base used by AI agent 160A, and/or the like.

Firstly, knowledge-transfer module 310 may identify knowledge elements, in knowledge repository 305, that are relevant to AI agent 160A. For example, knowledge-transfer module 310 may identify a set of knowledge elements that are associated with AI agents 160 that are semantically similar in one or more dimensions (e.g., objective, AI model(s) 162 utilized, tool(s) 164 utilized, etc.) to AI agent 160A. Alternatively or additionally, knowledge-transfer module 310 may identify a set of knowledge elements that are semantically similar to existing component elements within AI agent 160A. Semantic similarity may be determined using any suitable technique, based on any suitable semantic similarity metric. Generally, knowledge-transfer module 310 may identify knowledge elements by matching one or more source AI agents 160 to the receiving AI agent 160A based on a semantic similarity metric, and retrieving knowledge elements associated with at least one of the matching source AI agent(s) 160.

For instance, vector embeddings of the AI agents 160 and/or knowledge elements may be used to identify semantically similar AI agents 160 and/or knowledge elements. In this case, knowledge repository 305 may comprise a vector database, comprising embedding vectors for each source AI agent 160 and/or knowledge element within knowledge repository 305. The prospective receiving AI agent 160A and/or individual elements of the prospective receiving AI agent 160A may similarly be converted into embedding vectors. Each embedding vector represents text (e.g., textual description), from the respective data object (e.g., AI agent 160 or knowledge element), as a vector of real numbers, with each real number in the vector representing a semantic position of the text in one dimension of a vector space that comprises a plurality of dimensions. The vector space is generally highly dimensional, with at least one hundred, and typically hundreds of, dimensions. As a whole, each embedding vector represents the position of the respective data object within the vector space, with a pair of embedding vectors that are positioned closer to each other, within the vector space, being more semantically similar than a pair of embedding vectors that are positioned farther from each other within the vector space. The similarity between a pair of embedding vectors may be determined using any suitable similarity metric based, for example, on a distance between the pair of embedding vectors (e.g., Euclidean distance, Manhattan distance, cosine distance, Hamming distance, Minkowski distance, Chebyshev distance, Jaccard distance, Haversine distance, Sorensen-Dice distance, etc.). The search of the vector database for similar embedding vectors (e.g., representing source AI agents 160 or their respective knowledge elements) to an input embedding vector (e.g., representing the prospective receiving AI agent 160A) may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search (FAISS), Approximate Nearest Neighbors Oh Yeah (ANNOY), scalable nearest neighbors (ScaNN), etc.), Hierarchical Navigable Small World (HNSW) graphs, Inverted File Indexing (IVF), Voronoi diagrams, vector quantization, product quantization (PQ), random projection trees, lattice-based methods (e.g., cover tree, vantage point tree, etc.), and/or the like.

Secondly, knowledge-transfer module 310 may determine whether or not the identified semantically similar knowledge elements are compatible with AI agent 160A. For example, knowledge-transfer module 310 may execute an algorithmic compatibility analysis to determine whether each retrieved knowledge element can be effectively utilized by AI agent 160A. The compatibility analysis may generate a compatibility score for each knowledge element, retrieved from knowledge repository 305. In particular, the compatibility analysis may receive, as input, the knowledge element and one or more features of the receiving AI agent 160A, and output a compatibility score of the input knowledge element to the receiving AI agent 160A. The compatibility score may quantify the likelihood that the knowledge element is compatible with the architecture and operation of AI agent 160A based on factors, such as architectural similarity, domain relevance, and functional complementarity. When the compatibility score for a knowledge element satisfies (e.g., is greater than or equal to) a threshold, the knowledge element may be determined to be compatible with the receiving AI agent 160A. Conversely, when the compatibility score for a knowledge element does not satisfy (e.g., is less than) the threshold, the knowledge element may be determined to be incompatible with the receiving AI agent 160A. When a knowledge element is determined, by the compatibility analysis, to be incompatible with AI agent 160A, that knowledge element may be discarded from further consideration. In other words, the incompatible knowledge element will not be shared with the receiving AI agent 160A.

Thirdly, knowledge-transfer module 310 may transform the remaining knowledge elements, which now consist of only those knowledge elements that are compatible with the receiving AI agent 160A, into a format that can be incorporated into AI agent 160A. In particular, AI agents 160 may be defined according to different architectures, depending, for example, on the design software that was used, the developer that designed the AI agent 160, and/or the like. The compatible knowledge elements may be converted from the format used by the source AI agent 160 into the format used by AI agent 160A. Alternatively, knowledge elements may be converted into a standard internal format, at the time of being stored in knowledge repository 305, and the compatible knowledge elements may be converted from this internal format into the format used by AI agent 160A In other words, each compatible knowledge element may be converted from an existing format into a format that is compatible with the architecture of the receiving AI agent 160A. It should be understood that, in the event that the existing format is already compatible with the architecture of the receiving AI agent 160A, no conversion is necessary.

Fourthly, knowledge-transfer module 310 may generate a transfer process for incorporating the new knowledge elements into AI agent 160A, incrementally, over a time span. The time span may comprise minutes, hours, days, weeks, months, or the like. The transfer process, including potentially the time span, may be specifically tailored for AI agent 160A, based on one or more factors, in contrast to a one-size-fits-all manner. These factor(s) may include, without limitation, the architecture of AI agent 160A, whether or not AI agent 160A has been deployed, how long AI agent 160A has been deployed, the number of knowledge elements being incorporated into AI agent 160A, the type of knowledge elements being incorporated into AI agent 160A, the expected impact of the knowledge element(s) being incorporated into AI agent 160A to AI agent 160A, and/or the like. Alternatively, the transfer process may consist of immediately incorporating all of the new knowledge elements into AI agent 160A at once, instead of incorporating the new knowledge elements into AI agent 160A over a time span.

Notably, knowledge-transfer module 310 is capable of transferring knowledge at the level of individual discrete knowledge elements which form unitary components of the overall source AI agent 160. Thus, the knowledge to be transferred can be custom-tailored to the particular AI agent 160A that is receiving the knowledge, so as not to negatively impact the integrity or specialization of the receiving AI agent 160A. This is in contrast to a solution that simply copies all of the knowledge from one AI agent 160 to another.

At a high level, integrity-preservation module 320 ensures that the knowledge transfer to AI agent 160A does not compromise the specialization of the receiving AI agent 160A. In particular, AI agent 160A may have been designed or may have acquired behaviors and/or capabilities during deployment that are beneficial for the particular domain in which AI agent 160A operates. There is a risk that the transfer of a knowledge element from an AI agent 160 that does not operate in the same domain as AI agent 160A may cause AI agent 160A to lose its specialized knowledge for that domain.

Firstly, integrity-preservation module 320 may identify the core functions of AI agent 160A. For example, integrity-preservation module 320 may map out the capabilities and objectives that define the specialization of AI agent 160A. In particular, integrity-preservation module 320 may determine which component elements of AI agent 160A represent the specialized knowledge of AI agent 160A.

Secondly, integrity-preservation module 320 may analyze the knowledge transfer to determine whether or not there are any conflicts between the existing component elements of AI agent 160A, which have been determined to represent the specialized knowledge of AI agent 160A, and the one or more knowledge elements to be incorporated into AI agent 160A via the transfer process, generated by knowledge-transfer module 310. When a conflict is detected, between existing component elements and knowledge elements, integrity-preservation module 320 may execute an algorithmic reconciliation to identify the optimal strategy for resolving the conflict. For example, the reconciliation may comprise aborting the transfer process, removing the conflicting knowledge element(s) from the transfer process, replacing the conflicting knowledge element(s) with different compatible knowledge element(s) (e.g., from a different source AI agent 160), continuing with the as-is transfer process despite the conflict(s), or the like. The resolution may be performed automatically (i.e., without any user involvement), semi-automatically (e.g., after approval by a manager or developer of the receiving AI agent 160A), or manually (e.g., by a manager or developer of the receiving AI agent 160A).

Thirdly, integrity-preservation module 320 may assess the potential impact of the knowledge transfer on AI agent 160A. In particular, integrity-preservation module 320 may estimate or predict how the knowledge transfer will affect the specialized capabilities of AI agent 160A, based on one or more features of the transfer process (e.g., the knowledge elements to be incorporated into the receiving AI agent 160A). For instance, integrity-preservation module 320 may generate a quantitative numerical metric that represents the potential disruption of the knowledge transfer, represented by the transfer process, to the specialization of the receiving AI agent 160A. When this quantitative numerical metric satisfies (e.g., is greater than or equal to) a threshold, representing a significant diminishment of the specialized capabilities of the receiving AI agent 160A, integrity-preservation module 320 may abort the transfer process or modify the transfer process (e.g., replacing, adding, and/or removing knowledge elements, adjusting the time span, etc.) until the quantitative numerical metric for the transfer process does not satisfy the threshold. Conversely, when this quantitative numerical metric does not satisfy (e.g., is less than) the threshold, representing an insignificant or no diminishment of the specialized capabilities of the receiving AI agent 160A, integrity-preservation module 320 may allow the transfer process to proceed. The threshold may be configurable by a manager of AI agent 160A.

The quantitative numerical metric may be generated by a machine-learning model. For example, a machine-learning model may be trained to predict the quantitative numerical metric within a continuous range of values (e.g., zero to one, with zero representing no impact and one representing the maximum impact), based on one or more features of the knowledge transfer. Examples of features include, without limitation, one or more attributes of the receiving AI agent 160A (e.g., architecture), one or more attributes of the source AI agent 160A (e.g., architecture), one or more attributes of the knowledge element (e.g., type, descriptive text, etc.), and/or the like. The machine-learning model may be trained, using supervised learning, on a training dataset that comprises feature vectors, which each comprises one or more features and is labeled with a value representing whether or not the knowledge transfer, represented by that feature vector, was successful (e.g., zero for successful, one for unsuccessful). In supervised learning, the weights and other parameters of the machine-learning model are updated, in each of a plurality of training iterations, by inputting one of the feature vectors in the training dataset, and attempting to reduce an error, in the next iteration, between the value of the quantitative numerical metric, output by the machine-learning model for that feature vector, and the value of the quantitative numerical metric with which that feature vector is labeled.

Fourthly, integrity-preservation module 320 may implement isolation protocols for the knowledge transfer to AI agent 160A. The isolation protocols may create boundaries that prevent transferred knowledge elements from interfering with the core functions of AI agent 160A that are essential to the specialization of AI agent 160A. In particular, the isolation protocols may prevent the transferred knowledge elements from replacing, modifying, or conflicting with the operation of the component element(s) in AI agent 160A that represent the specialized knowledge of AI agent 160A. Integrity-preservation module 320 may add the isolation protocol(s) to the transfer process, to prevent the knowledge elements, included in the transfer process, from interacting with component element(s) of the receiving AI agent 160A (e.g., representing the specialized capabilities of the receiving AI agent 160A).

Fifthly, integrity-preservation module 320 may provide rollback capability. As mentioned elsewhere herein, knowledge repository 305 may store each version of knowledge elements of source AI agents 160 that are stored in knowledge repository 305 for knowledge transfer. In addition, knowledge repository 305 may store the previously existing version of each component element of receiving AI agent 160A that is replaced or modified by knowledge elements during the knowledge transfer. Thus, in the event that an issue is subsequently detected with AI agent 160A (e.g., the loss of a specialized capability), integrity-preservation module 320 may restore the previously existing version of each component element that is causing the issue (e.g., the component element(s) responsible for the specialized capability that was lost). This enables the quick rollback of problematic transferred knowledge from AI agent 160A.

At a high level, adaptive-learning module 330 provides a framework for transferring knowledge to AI model 160A according to the transfer process, generated by knowledge-transfer module 310. In other words, adaptive-learning module 330 implements the transfer process for gradually or incrementally incorporating knowledge elements into AI agent 160A over a time span. If the transfer process is successful, at the end of the transfer process, adaptive-learning module 330 will have incorporated all of the knowledge elements, that have been included in the transfer process from knowledge repository 305, into the architecture of AI agent 160A.

This incremental knowledge transfer minimizes disruption to AI agent 160A. For instance, a first knowledge element may be incorporated into AI agent 160A at a first time, and if no issues are detected (e.g., by monitoring-and-optimization module 340) after a first time duration, a second knowledge element may be incorporated into AI agent 160A at a second time, according to the transfer process. Similarly, if no issues are detected after a second time duration, a third knowledge element may be incorporated into AI agent 160A at a third time, according to the transfer process, and so on and so forth, until all of the knowledge elements in the transfer process have been incorporated into the receiving AI agent 160A. Notably, this enables troubleshooting. For example, if an issue is detected by monitoring-and-optimization module 340 during the second time duration, it can be inferred that the transfer of the second knowledge element caused the issue. In this case, monitoring-and-optimization module 340 could inform integrity-preservation module 320, which may responsively rollback the second knowledge element (i.e., replace the second knowledge element with the previous version of the corresponding component element of AI agent 160A stored in knowledge repository 305).

In other words, a transfer process, which transfers a plurality of knowledge elements, may comprises checkpoints after each knowledge element or sets of two or more knowledge elements. At each checkpoint, it may be determined (e.g., by monitoring-and-optimization module 340) whether or not there are any issues, which may indicate an unsuccessful knowledge transfer or the likelihood of an unsuccessful knowledge transfer. When detecting an issue, the transfer process may be aborted, and any knowledge elements that have been incorporated, since the last successful checkpoint or since the start of the transfer process, may be rolled back. Alternatively or additionally, one or more other remedial actions may be performed, such as notifying a manager or developer of AI agent 160A, automatically terminating or constraining execution of AI agent 160, and/or the like.

In an embodiment, the transfer process is executed automatically. In an alternative embodiment, the transfer process is executed semi-automatically, by suggesting the transfer process to a user (e.g., within a graphical user interface of user interface 115), who may either approve or disapprove of the transfer process (e.g., via an input of the graphical user interface), modify and then approve the transfer process (e.g., via one or more inputs of the graphical user interface), or the like. In yet another alternative embodiment, the transfer process may be executed manually by a user, who may manually update AI agent 160A with the suggested knowledge elements, in accordance with the transfer process.

Adaptive-learning module 330 may comprise or be communicatively coupled to a test environment of computing environment 150. In particular, prior to performing the transfer process in a production environment of computing environment 150 or deploying the receiving AI agent 160A into the production environment, adaptive-learning module 330 may instantiate AI agent 160A in a testing environment (i.e., sandbox), in which AI agent 160A cannot actually modify any production data. Adaptive-learning module 330 may utilize a simulation engine to execute the transfer process within the testing environment, in one or more, and preferably a plurality of, scenarios. The impact of the transfer process on AI agent 160A can be evaluated within the testing environment, before actual implementation of the transfer process within the production environment or the deployment of AI agent 160A to the production environment. If AI agent 160A has issues (e.g., loses specialized capabilities) within the testing environment, the transfer process may be modified or canceled, one or more knowledge elements that are to be transferred by the transfer process may be removed from the transfer process or modified, and/or the like.

At a high level, monitoring-and-optimization module 340 evaluates the effectiveness of each knowledge transfer and improves one or more modules of knowledge manager 116 based on the evaluations. Monitoring-and-optimization module 340 may monitor the long-term impact of knowledge transfers on performance of AI agents 160A, refine knowledge manager 116 (e.g., knowledge-transfer module 310, integrity-preservation module 320, adaptive-learning module 330, etc.) based on operational data, and/or update the metadata for knowledge elements within knowledge repository 305 with performance metrics, utilization metrics, and/or the like.

Firstly, monitoring-and-optimization module 340 gathers data on how each knowledge transfer impacts the operations of the AI agent 160A that received the knowledge transfer. The data may comprise one or more performance metrics for AI agent 160A. Examples of performance metrics that may be collected by monitoring-and-optimization module 340 include, without limitation, time-related metrics (e.g., mean response time), guardrail-related metrics (e.g., number or rate of false positives in which a guardrail is invoked when it should not have been, number or rate of false negatives in which a guardrail was not invoked when it should have been, etc.), utilization metrics (e.g., number of users, number of uses, etc.), user feedback (e.g., a numerical feedback score representing user satisfaction with responses provided by AI agent 160A), and/or the like. Monitoring-and-optimization module 340 may determine, at one or more checkpoints during the transfer process and/or after the transfer process for a receiving AI agent 160, how AI agent 160A is performing against established baselines. Monitoring-and-optimization module 340 may also verify, at one or more checkpoints during the transfer process and/or after the transfer process for a receiving AI agent 160, whether or not the specialization and/or core functions of the receiving AI agent 160 have been preserved or diminished.

Secondly, monitoring-and-optimization module 340 may analyze the utilization of knowledge elements within AI agents 160, to identify which shared knowledge elements provide the most value. For example, monitoring-and-optimization module 340 may analyze the performance metrics for AI agents 160 to identify high-performing AI agents 160. Then, monitoring-and-optimization module 340 may determine which knowledge elements are shared across a substantial subset of the high-performing AI agents 160. It may be inferred that these knowledge elements have a beneficial impact on AI agents 160. Alternatively or additionally, monitoring-and-optimization module 340 may compare the performance metrics of each AI agent 160A, before and after a knowledge transfer, to determine the amount of increase (or decrease) in performance by AI agents 160A. Over a plurality of these evaluations of AI agents 160A, monitoring-and-optimization module 340 may determine knowledge transfers that produce the largest increase (e.g., in terms of percentage increase) in the performance of AI agents 160A, and identify the knowledge element(s) within those knowledge transfers as having a beneficial impact on AI agents 160A. Similarly, monitoring-and-optimization module 340 may determine knowledge transfers that produce the smallest increase or largest decrease (e.g., in terms of percentage increase or decrease) in performance of AI agents 160A, identify the knowledge element(s) within those knowledge transfers as having no beneficial impact or a negative impact on AI agents 160A, and exclude or otherwise reduce the inclusion of such knowledge elements in future knowledge transfers.

Thirdly, monitoring-and-optimization module 340 may optimize one or more other modules within knowledge manager 116. For instance, monitoring-and-optimization module 340 may incorporate feedback into knowledge-transfer module 310 to improve the identification of knowledge elements from knowledge repository 305, the identification of compatible knowledge elements, the transformation of knowledge elements into the respective formats of AI agents 160A, the generation of the transfer process, and/or the like. Similarly, monitoring-and-optimization module 340 may incorporate feedback into integrity-preservation module 320 to improve the identification of the core functions of receiving AI agents 160A, the detection of conflicts between knowledge elements and component elements of receiving AI agents 160A, the generation of the quantitative numerical metric, the implementation of isolation protocols, and/or the like. The feedback may comprise an indication of whether or not a knowledge transfer was successful, an identification of knowledge elements that had a beneficial impact and/or negative impact on the performance of AI agents 160A, and/or the like. In this manner, knowledge manager 116 may continuously improve the knowledge-transfer protocol over time, based on the outcomes of knowledge transfers.

Fourthly, monitoring-and-optimization module 340 may proactively suggest beneficial knowledge transfers. For example, monitoring-and-optimization module 340 may detect an AI agent 160A with relatively low performance metrics (e.g., one or more performance metrics satisfy a threshold representing low performance or utilization), and in response to detecting the low-performing AI agent 160A, input information about the low-performing AI agent 160A to knowledge-transfer module 310 to generate and implement a transfer process for transferring knowledge (i.e., in the form of one or more knowledge elements) to AI agent 160A.

Fifthly, monitoring-and-optimization module 340 may identify high-performing AI agents 160, based on their respective performance metric(s), to identify knowledge elements to be added to knowledge repository 305. For example, AI agents 160 with performance metric(s) that are high, relative to other AI agents 160, may be identified as high-performing AI agents 160. One or more, including potentially all of, the knowledge elements from this high-performing AI agents 160 may be tagged (e.g., with classifications), as discussed elsewhere herein, and added to knowledge repository 305, as well as potentially other metadata, in association with a representation (e.g., embedding vector) of the high-performing source AI agent 160 for the purposes of searching knowledge repository 305, by knowledge-transfer module 310, for matching AI agents 160 to an AI agent 160A of interest. In an embodiment, the metadata for each knowledge element in knowledge repository 305 may also comprise any contextual dependencies required for the functionality of the knowledge element, as well as performance metrics, utilization metrics, and/or the like. These contextual dependencies may be packaged with the knowledge element during any transfers of the knowledge element to a receiving AI agent 160A, so that the receiving AI agent 160A has the necessary contextual dependencies for the knowledge element.

In an embodiment, knowledge manager 116 may implement a retrieval-augmented generation (RAG) architecture. The RAG architecture combines a retrieval-based component, represented by the retrieval of knowledge elements from knowledge repository 305, with a generation-based component, represented by the interaction with an AI model, which may be a large language model, small language model, other generative language model, or other type of model. The RAG architecture provides dynamic and scalable access to a knowledge base (e.g., knowledge repository 305), improved generalization (e.g., enabling the AI model to respond to prompts beyond those for which the AI model was trained), and reduced model size (e.g., since the AI model does not need to store all relevant data internally). Suitable enhancements to the RAG architecture, which may be used, include Chunked RAG (CRAG), in which the retrieval-based component retrieves relevant chunks of knowledge repository 305, and Self-RAG, in which the retrieval-based component is able to retrieve information from a store of prior responses, as well as from knowledge repository 305.

In the generation component of the RAG architecture, knowledge manager 116 may generate an input to the AI model based, for example, on the knowledge elements, including their associated metadata, retrieved from knowledge repository 305 in the retrieval component of the RAG architecture. In particular, knowledge manager 116 may incorporate relevant data into a predefined template to generate a prompt, which may comprise or consist of a natural-language expression. The predefined template may comprise a pre-conversation and/or post-conversation, which provide context and/or instructions for the AI model, and one or more placeholders into which the relevant data are inserted. The pre-conversation and/or post-conversation may define the role of the AI model (e.g., determine the compatibility of knowledge elements, select compatible knowledge elements to be included in the transfer process, generate the transfer process, identify conflicts between knowledge elements and component elements of a receiving AI agent 160A, etc.), define an output format for the AI model (e.g., natural language, a table, a list structure, a hierarchical structure, a markup-language structure, etc.), and/or the like. The prompt is input to the AI model to produce a response from the AI model (e.g., in the output format defined by the prompt). This response may be used as an input to any of the disclosed functions of knowledge-transfer module 310, integrity-preservation module 320, adaptive-learning module 330, and/or monitoring-and-optimization module 340.

In an embodiment, each AI agent 160 may implement a cross-agent collaboration interface 350. Cross-agent collaboration interface 350 enables two AI agents 160 to engage in an interaction for sharing knowledge. Cross-agent collaboration interface 350 may implement a knowledge-request protocol that provides a standardized format for a first AI agent 160A to request knowledge from a second AI agent 160B, and for the second AI agent 160B to transfer that knowledge to the first AI agent 160A. For example, the first AI agent 160A may utilize the knowledge-request protocol to request a particular capability from the second AI agent 160B, and the second AI agent 160B may, in response to that request, transfer one or more knowledge elements, representing that capability, to the first AI agent 160A. The first AI agent 160A may then incorporate the transferred knowledge element(s) into its architecture. The knowledge-request protocol may be a peer-to-peer protocol in which AI agents 160 communicate directly with each other to share knowledge, or may utilize an intermediary, such as knowledge manager 116, to relay messages between a pair of knowledge-sharing AI agents 160.

The knowledge-request protocol may implement a negotiation framework, which enables AI agents 160 to establish terms and conditions for knowledge sharing. In particular, the knowledge-request protocol may enable the first AI agent 160A or the second AI agent 160B to offer one or more terms for knowledge sharing, and the other AI agent 160 may either accept the term(s) or return a counteroffer. It should be understood that there may be any number of iterations of offers and counteroffers, until an agreement is reached or a counteroffer is finally rejected. According to this bidirectional verification protocol, the first AI agent 160A and the second AI agent 160B may validate the knowledge transfer through a consensus mechanism before execution of the knowledge transfer. Examples of terms include, without limitation, the requirement that the AI agent 160A that receives the knowledge adds or modifies one or more guardrails, enhances applicable security protocols (e.g., requiring a stronger form of authentication), refrain from using one or more models 162 and/or tools 164, only uses specified model(s) 162 and/or tool(s) 164, and/or the like.

In an embodiment, cross-agent collaboration interface 350 may comprise a specialization-preserving application programming interface, which allows AI agents 160 to access external knowledge without direct incorporation of knowledge elements. In particular, the first AI agent 160A may send, via the specialization-preserving application programming interface of the second AI agent 160B, a request for access to a knowledge element, such as a knowledge base, AI model 162, tool 164, or the like, of the second AI agent 160B, along with an input (e.g., query) for the knowledge element for which access is being requested. The second AI agent 160B may determine whether or not to grant access to the knowledge element. When determining to grant access to the knowledge element, the second AI agent 160B may provide the input, from the first AI agent 160A, to the knowledge element, and return the response of the knowledge element to the first AI agent 160A. Otherwise, when determining not to grant access to the knowledge element, the second AI agent 160B may return a denial to the first AI agent 160A. The specialization-preserving application programming interface, in combination with the knowledge transfer, implemented by knowledge manager 116, provides a framework by which AI agents 160 may selectively internalize certain knowledge elements while selectively externalizing other knowledge elements.

Cross-agent collaboration interface 350 may implement a multi-tiered memory system that allows AI agents 160 to selectively externalize and share episodic, procedural, and declarative memory elements, while maintaining private memory elements. This multi-tiered memory system may include, without limitation, a memory access control layer, a memory synchronization protocol, temporal memory sharing, and/or adaptive memory segregation. The memory access control layer may provide granular permissions that determine which memory elements of AI agent 160 (e.g., AI agent 160B) are shareable with other AI agents 160 (e.g., AI agent 160A). The memory synchronization protocol may ensure consistency across instances of shared memory elements, when a plurality of AI agents 160 access the same knowledge base. Temporal memory sharing refers to time-bound sharing of memory element(s) for collaborative tasks between two or more AI agents 160, without permanent transfer. After the end of the set time period, representing the time period of collaboration, the sharing of the memory element(s) may be automatically terminated. The memory attribution tracking maintains a lineage of shared memory elements, to establish provenance and enable quality assessment. The adaptive memory segregation refers to the dynamic determination of which memory elements should remain private and which memory elements should be shared, based on utilization patterns and security considerations.

In an embodiment, the knowledge-request protocol maps the relationships between knowledge elements that are transferred between AI agents 160, such that the source of each transferred-in knowledge element in each AI agent 160A can be traced back to the source AI agent 160. For instance, if second AI agent 160B transfers a knowledge element to first AI agent 160A, the knowledge-request protocol may record a child relationship between that knowledge element in the first AI agent 160A relative to that knowledge element in the second AI agent 160B. The knowledge-request protocol may record these relationships within knowledge repository 305 or another database (e.g., within database 114), every time a new relationship is created using the transfer process implemented by adaptive-learning module 330 or via cross-agent collaboration interface 350. Alternatively or additionally, each relationship may be stored in the local memory of each AI agent 160. For instance, if second AI agent 160B transfers a knowledge element to first AI agent 160A, the knowledge-request protocol may record a child relationship, between that knowledge element in the first AI agent 160A relative to that knowledge element in the second AI agent 160B, in the local memory of the first AI agent 160A, and/or a parent relationship between that knowledge element in the second AI agent 160B relative to that knowledge element in the first AI agent 160A, in the local memory of the second AI agent 160B.

In an embodiment, when the source AI agent 160 for a knowledge element, which has been shared with one or more receiving AI agents 160, updates that knowledge element, the update may be propagated to each of the receiving AI agents 160, by following the mapping of relationship(s) for that knowledge element. The propagation of updates may be either automatic (e.g., with no user intervention), semi-automatic (e.g., with the approval of a manager or developer of each receiving AI agent 160), or manual (e.g., by the manager or developer of each receiving AI agent 160).

In an embodiment, cross-agent collaboration interface 350 may also enable a plurality of AI agents 160 to work together on complex tasks. For example, the knowledge-request protocol may be used by a first AI agent 160A to query a second AI agent 160B as to whether or not the second AI agent 160B has a particular capability. The second AI agent 160B may respond as to whether or not it has the queried capability. If the second AI agent 160B responds in the affirmative, the first AI agent 160A may either request knowledge sharing of that capability, as discussed above, or utilize the second AI agent 160B as a tool 164 to perform a sub-task, of the overall task of the first AI agent 160A, that requires that capability.

### 4. Overall Process

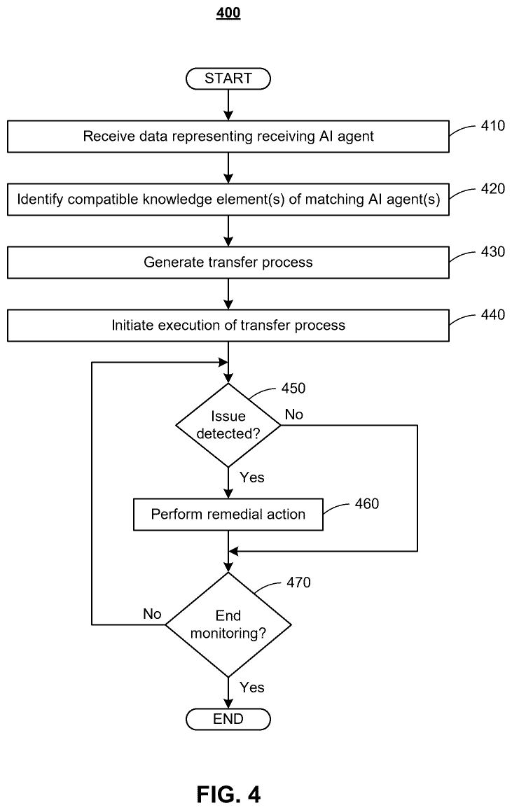

FIG. 4 illustrates an example process 400 for knowledge transfer between AI agents 160, according to an embodiment. Process 400 may be implemented by knowledge manager 116. Process 400 may be executed for an AI agent 160A whenever the AI agent 160A becomes a candidate for receiving a transfer of knowledge. An AI agent 160A may become such a candidate, automatically, semi-automatically, or manually, when AI agent 160A is being constructed in a design phase, when AI agent 160A is being deployed to a production or test environment of computing environment 150, in response to a user operation (e.g., selection of an input within a graphical user interface), when one or more performance metrics for AI agent 160A indicate poor performance (e.g., as detected by monitoring-and-optimization module 340), and/or the like. It should be understood that process 400 may be executed for each of a plurality of receiving AI agents 160A.

While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410, which may be implemented by knowledge-transfer module 310, may receive data representing the receiving AI agent 160A. The received data may comprise the specification of the receiving AI agent 160A, which may comprise an identifier of each AI model 162, identifier of each tool 164, instruction(s), a chain of reasoning, input format and/or output format, an identifier of a knowledge base, and/or the like, used by the receiving AI agent 160A. The receiving AI agent 160A may be not yet deployed, in which case, the knowledge transfer may solve the cold-start problem by initializing a new AI agent 160A with knowledge prior to deployment. Alternatively, the receiving AI agent 160A may be deployed in a test environment or production environment of computing environment 150. In this case, the knowledge transfer may be intended to boost the performance of the receiving AI agent 160A, without diminishing the specialization of the receiving AI agent 160A.

Subprocess 420, which may be implemented by knowledge-transfer module 310 and/or integrity-preservation module 320, may identify one or more compatible knowledge elements, associated in knowledge repository 305 with one or more source AI agents 160 that match the receiving AI agent 160A, and which are compatible with the receiving AI agent 160A, based on data received in subprocess 410. Each of the identified compatible knowledge element(s) may comprise a learned behavior, acquired skill, agentic configuration, identifier of an AI model, identifier of a tool, an instruction, a chain of reasoning, an objective, an input format, and output format, an identifier of a knowledge base, and/or the like.

The compatible knowledge element(s) may be identified by matching source AI agents 160, represented in knowledge repository 305, to the receiving AI agent 160A based on a semantic similarity metric, and retrieving one or more knowledge elements associated with at least one of the matching source AI agents 160. For each of at least a subset of the retrieved knowledge element(s), a compatibility score may be generated for that retrieved knowledge element, and it may be determined whether or not to include the retrieved knowledge element in the one or more compatible knowledge elements, to be transferred, based on the compatibility score. For each of at least a subset of the retrieved knowledge element(s), it may be determined whether or not that retrieved knowledge element conflicts with a component element of the receiving AI agent 160A, and when determining that the retrieved knowledge element conflicts with the component element of the receiving AI agent 160A, the retrieved knowledge element may be excluded from the knowledge element(s) that are transferred to the receiving AI agent 160A.

In an embodiment, a plurality of knowledge elements that are associated with matching source AI agents 160, within knowledge repository 305, may be extracted. As mentioned above, a compatibility score may be generated for each of the plurality of knowledge elements, and one or more compatible knowledge elements may be identified, from the plurality of knowledge elements, based on the generated compatibility scores for the plurality of knowledge elements. The compatibility score for each of the plurality of knowledge elements may be based on one or more of an architectural similarity between the receiving AI agent 160A and the one of the identified plurality of source AI agents 160 with which the knowledge element is associated, a domain of the one of the identified plurality of source AI agents 160 with which the knowledge element is associated, or the complementarity of a function of the one of the identified plurality of source AI agents 160 with which the knowledge element is associated to a function of the receiving AI agent 160A.

Subprocess 420 may further comprise transforming each of the compatible knowledge element(s), to be transferred to the receiving AI agent 160A, from an existing format into a format that is used by the architecture of the receiving AI agent 160A. The existing format may be the format used by the source AI agent 160, from which the knowledge element was extracted. Alternatively, the existing format may be a standard internal format into which all knowledge elements are converted for storage within knowledge repository 305.

Subprocess 430, which may be implemented by knowledge-transfer module 310, may generate a transfer process that incorporates each of the compatible knowledge element(s), identified in subprocess 420, into an architecture of the receiving AI agent 160A over a time span. It should be understood that knowledge elements that are identified from matching source AI agents 160, within knowledge repository 305, may be filtered based on compatibility, as discussed above, as well as other factors, such as an impact assessment (e.g., conflict, the quantitative numerical metric, etc., as discussed elsewhere herein). A set of one or more of these filtered knowledge elements may then be selected for the transfer process based on one or more criteria, which are generally designed to optimize the performance of the receiving AI agent 160A without compromising the specialized capabilities of the receiving AI agent 160A.

Subprocess 440, which may be implemented by adaptive-learning module 330, may execute the transfer process, generated in subprocess 430, to incorporate each of the selected compatible knowledge element(s) into the architecture of the receiving AI agent 160A over the time span dictated by the transfer process. During the transfer process, each knowledge element in the transfer process may be sent to the receiving AI agent 160A, in the format of the architecture of the receiving AI agent 160A. The receiving AI agent 160A may incorporate each received knowledge element into the architecture of the receiving AI agent 160A. This incorporation may comprise replacing a component element of the receiving AI agent 160A with the received knowledge element, modifying a component element of the receiving AI agent 160A based on the received knowledge element, adding the received knowledge element as a new component element of the receiving AI agent 160A, and/or the like. In an embodiment, the transfer process may include one or more isolation protocols that prevent the incorporated knowledge elements from interacting with one or more other component elements of the receiving AI agent 160A, such as the component elements that have been determined to represent the specialized capabilities of the receiving AI agent 160A.

The transfer process may comprise transferring knowledge elements incrementally at different times. For example, the knowledge transfer may comprise a first knowledge element and a second knowledge element. In this case, execution of the transfer process may comprise, during a time span, incorporating the first knowledge element into the receiving AI agent 160A at a first time within the time span, and the incorporating the second knowledge element into the receiving AI agent 160A at a second time, within the time span, that is subsequent to the first time by a time duration.

Subprocess 450, which may be implemented by monitoring-and-optimization module 340, may determine whether or not any issues are detected in the operation of the receiving AI agent 160A. In particular, subprocess 450 may monitor one or more performance metrics of the receiving AI agent 160A before, during, and/or after the transfer process. An issue may be detected when the performance metric(s) indicate a deterioration in performance of the receiving AI agent 160A after the incorporation of a knowledge element during the transfer process. The deterioration in performance may represent a reduction in the specialized capabilities of the receiving AI agent 160A (e.g., as reflected by an increase in the negativity of user feedback). When detecting an issue (i.e., “Yes” in subprocess 450), process 400 may proceed to subprocess 460. Otherwise, while not detecting an issue (i.e., “No” in subprocess 450), process 400 may proceed to subprocess 470.

As an example, monitoring-and-optimization module 340 may, for each receiving AI agent 160A, collect one or more prior performance metrics for the receiving AI agent 160A before the execution of the transfer process (e.g., before subprocess 440), and then collect one or more subsequent performance metrics for the receiving AI agent 160A after the execution of the transfer process. It should be understood that the prior and subsequent performance metric(s) will be the same performance metric(s), but will generally have different values, reflecting a change (e.g., increase or decrease) in performance of the receiving AI agent 160A. Thus, monitoring-and-optimization module 340 may determine the change in performance of the receiving AI agent 160A based on the difference between the prior performance metric(s) and the subsequent performance metric(s). The performance metric(s) may comprise a feedback score, representing the positivity or negativity of user feedback to responses provided by the receiving AI agent 160A.

Subprocess 460, which may be implemented by monitoring-and-optimization module 340, may perform a remedial action to resolve the issue(s) detected in subprocess 450. The remedial action may comprise rolling back at least one of the knowledge elements that was incorporated into the receiving AI agent 160A during the transfer process, and potentially rolling back all of the knowledge elements that were incorporated into the receiving AI agent 160A during the transfer process (i.e., rolling back the entire transfer process). Additionally or alternatively, the remedial action may comprise un-deploying the receiving AI agent 160A, limiting the operation of receiving AI agent 160A (e.g., in terms of accessible models 162, tools 164, or other resources, allocated computational resources, etc.), notifying a manager or developer of the receiving AI agent 160A, and/or the like.

As discussed elsewhere herein, the transfer process may be incremental. The knowledge transfer, represented by the transfer process, may comprise a plurality of knowledge elements. In this case, subprocess 450 may acquire the performance metric(s) before and after the incorporation of each of the plurality of knowledge elements into the receiving AI agent 160A. For example, monitoring-and-optimization module 340 may collect one or more prior performance metrics for the receiving AI agent 160A before the execution of a transfer process that includes at least a first knowledge element and a second knowledge element. During the time span of the transfer process, the first knowledge element may be incorporated into the receiving AI agent at a first time within the time span, and monitoring-and-optimization module 340 may collect one or more subsequent performance metrics for the receiving AI agent 160A after the first time and before any additional knowledge elements are incorporated into the receiving AI agent 160A. Then, monitoring-and-optimization module 340 may determine a change in performance of the receiving AI agent 160A based on a difference between the prior performance metric(s) and the subsequent performance metric(s). When the change in performance is positive, the second knowledge element may be incorporated into the receiving AI agent 160A at a second time, within the time span, that is subsequent to the first time. Conversely, when the change in performance is negative, monitoring-and-optimization module 340 may roll back the incorporation of the first knowledge element into the receiving AI agent 160A. At this point, monitoring-and-optimization module 340 may terminate the transfer process, continue the transfer process with the second knowledge element, notify a manager or developer of the receiving AI agent 160A, and/or perform some other fallback process.

Subprocess 470, which may be implemented by monitoring-and-optimization module 340, may determine whether or not to end the monitoring of the receiving AI agent 160A. Monitoring-and-optimization module 340 may determine to end the monitoring of the receiving AI agent 160A after a fixed time period has elapsed from the completion of the transfer process, after the performance metric(s) of the receiving AI agent 160A have satisfied one or more success conditions for at least a fixed time period, in response to a user operation, in response to the receiving AI agent 160A been undeployed, and/or in the response to any other suitable trigger. When determining to end the monitoring of the receiving AI agent 160A (i.e., “Yes” in subprocess 470), process 400 may end. Otherwise, when not determining to end the monitoring of the receiving AI agent 160A (i.e., “No” in subprocess 470), process 400 may return to subprocess 450.

Although not illustrated, in an embodiment, a cross-agent collaboration interface 350 may be provided for knowledge transfer between two or more AI agents 160, in real time with the operation of those AI agents 160. As used herein, the term “real time” or “real-time” refers to events that occur simultaneously, as well as events that are separated in time by ordinary latencies in processing, memory access, communications, and/or the like. A first AI agent 160A may utilize cross-agent collaboration interface 350, between the first AI agent 160A and a second AI agent 160B, to request a capability from the second AI agent 160B, according to a knowledge-request protocol implemented by cross-agent collaboration interface 350. The knowledge-request protocol may also provide a negotiation protocol that allows the first AI agent 160A and the second AI agent 160B to negotiate the terms of use for the requested capability. These term(s) may require the first AI agent 160A to implement certain guardrails around the capability. Responsive to the request and at the completion of any negotiations (if implemented), the first AI agent 160A may receive at least one knowledge element, representing the requested capability, from the second AI agent 160B, and incorporate the received knowledge element(s) into an architecture of the first AI agent 160A. The knowledge-request protocol may store a relationship or mapping between the at least one knowledge element and the second AI agent 160B. This relationship may be stored within the local memory of the first AI agent 160A, within knowledge repository 305, and/or within another database (e.g., 114).

Although not illustrated, monitoring-and-optimization module 340 may identify one or more relatively high-performing AI agents 160, based on their collected performance metrics. For each of the one or more high-performing AI agents, monitoring-and-optimization module 340 may extract one or more knowledge elements from the high-performing AI agent 160, and add the extracted knowledge element(s) to knowledge repository 305. In addition, for each of the one or more high-performing AI agents 160 and for each of the extracted knowledge element(s), monitoring-and-optimization module 340 may classify the knowledge element into a classification in each of a plurality of dimensions, and add the classifications in the plurality of dimensions to metadata associated with the knowledge element within knowledge repository 305. These high-performing AI agents 160 become the source AI agents 160 for the knowledge transferred to receiving AI agents 160A.

### 5. Example Embodiment

Disclosed embodiments enable selective knowledge sharing between AI agents 160, while preserving the individual specializations of AI agents 160. A structured knowledge repository 305 is supplied with a pipeline of knowledge elements, from high-performing AI agents 160, by monitoring-and-optimization module 340. In this manner, high-performing AI agents 160 contribute knowledge elements, which may include learned behaviors, acquired skills, agentic configurations, tools 164, and/or the like, to knowledge repository 305.

Knowledge manager 116 transfers knowledge from knowledge repository 305 to receiving AI agents 160A, as discrete knowledge elements, such that receiving AI agents 160A incorporates the transferred knowledge elements. Knowledge manager 116 implements mechanisms for ensuring that the knowledge transfer does not compromise the integrity of receiving AI agents 160A, and optimizing the knowledge transfers. In addition, a cross-agent collaboration interface 350 may be provided for knowledge sharing and collaboration between a plurality of AI agents 160. Collectively, these features of disclosed embodiments provide an ecosystem of specialized AI agents 160 that benefit from collective learning while maintaining their defined roles.

Advantageously, disclosed embodiments solve the challenge of enabling targeted knowledge transfer, between AI agents 160, while maintaining their individual expertise, and preventing skill drift that would compromise their specialized functions. This structured approach enables AI agents 160 to selectively share and incorporate knowledge that enhances their capabilities, without diluting their core functions.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, for each of one or more receiving artificial intelligence (AI) agents:
receive data representing the receiving AI agent;
identify one or more compatible knowledge elements, which are compatible with the receiving AI agent, and which are associated in a knowledge repository with one or more source AI agents that match the receiving AI agent, based on the received data;
generate a transfer process that incorporates each of the one or more compatible knowledge elements into an architecture of the receiving AI agent over a time span; and
execute the transfer process to incorporate each of the one or more compatible knowledge elements into the architecture of the receiving AI agent over the time span.

2. The method of claim 1, wherein the one or more compatible knowledge elements comprise a first knowledge element and a second knowledge element, and wherein executing the transfer process comprises, during the time span:
incorporating the first knowledge element into the receiving AI agent at a first time within the time span; and
incorporating the second knowledge element into the receiving AI agent at a second time, within the time span, that is subsequent to the first time.

3. The method of claim 1, further comprising using the at least one hardware processor to, for each of the one or more receiving AI agents:
collect one or more prior performance metrics for the receiving AI agent before the execution of the transfer process;
collect one or more subsequent performance metrics for the receiving AI agent after the execution of the transfer process; and
determine a change in performance of the receiving AI agent based on a difference between the one or more prior performance metrics and the one or more subsequent performance metrics.

4. The method of claim 1,
wherein the one or more compatible knowledge elements comprise a first knowledge element and a second knowledge element,
wherein the method further comprises, for each of the one or more receiving AI agents, collecting one or more prior performance metrics for the receiving AI agent before the execution of the transfer process, and
wherein executing the transfer process comprises, during the time span:
incorporating the first knowledge element into the receiving AI agent at a first time within the time span;
collecting one or more subsequent performance metrics for the receiving AI agent after the first time;
determining a change in performance of the receiving AI agent based on a difference between the one or more prior performance metrics and the one or more subsequent performance metrics;
when the change in performance is positive, incorporating the second knowledge element into the receiving AI agent at a second time, within the time span, that is subsequent to the first time; and
when the change in performance is negative, rolling back the incorporation of the first knowledge element into the receiving AI agent.

5. The method of claim 1, wherein each of the one or more compatible knowledge elements comprises one or more of a learned behavior, acquired skill, agentic configuration, identifier of an AI model, identifier of a tool, an instruction, a chain of reasoning, an objective, an input format, an output format, or an identifier of a knowledge base.

6. The method of claim 1, wherein identifying the one or more compatible knowledge elements comprises:
identifying a plurality of source AI agents that matches the receiving AI agent;
extracting a plurality of knowledge elements that are associated with the identified plurality of source AI agents within the knowledge repository;
generating a compatibility score for each of the plurality of knowledge elements; and
identifying the one or more compatible knowledge elements, from the plurality of knowledge elements, based on the generated compatibility scores for the plurality of knowledge elements.

7. The method of claim 6, wherein the compatibility score for each of the plurality of knowledge elements is based on one or more of an architectural similarity between the receiving AI agent and one of the identified plurality of source AI agents with which the knowledge element is associated, a domain of the one of the identified plurality of source AI agents with which the knowledge element is associated, or a complementarity of a function of the one of the identified plurality of source AI agents with which the knowledge element is associated to a function of the receiving AI agent.

8. The method of claim 1, further comprising using the at least one hardware processor to, by a first AI agent:
utilize a cross-agent collaboration interface, between the first AI agent and a second AI agent, to request a capability from the second AI agent, according to a knowledge-request protocol;
receive at least one knowledge element, representing the requested capability, from the second AI agent; and
incorporate the at least one knowledge element into an architecture of the first AI agent.

9. The method of claim 8, further comprising using the at least one hardware processor to, by the first AI agent, store a relationship between the at least one knowledge element and the second AI agent.

10. The method of claim 9, wherein the relationship is a child relationship and is stored within a local memory of the first AI agent.

11. The method of claim 8, wherein the knowledge-request protocol is a peer-to-peer protocol, such that the first AI agent requests the capability directly from the second AI agent and receives the at least one knowledge element directly from the second AI agent.

12. The method of claim 1, further comprising using the at least one hardware processor to, for each of the one or more receiving AI agents, for each of the one or more compatible knowledge elements, transform the compatible knowledge element into a format used by the architecture of the receiving AI agent.

13. The method of claim 1, wherein identifying the one or more compatible knowledge elements comprises:
matching the one or more source AI agents to the receiving AI agent based on a semantic similarity metric; and
retrieving one or more knowledge elements associated with at least one of the matching one or more source AI agents.

14. The method of claim 13, wherein identifying the one or more compatible knowledge elements further comprises, for each of at least a subset of the retrieved one or more knowledge elements:
generating a compatibility score for that retrieved knowledge element; and
determining whether or not to include the retrieved knowledge element in the one or more compatible knowledge elements based on the compatibility score.

15. The method of claim 13, wherein identifying the one or more compatible knowledge elements further comprises, for each of at least a subset of the retrieved one or more knowledge elements:
determining whether or not that retrieved knowledge element conflicts with a component element of the receiving AI agent; and
when determining that the retrieved knowledge element conflicts with the component element of the receiving AI agent, excluding the retrieved knowledge element from the one or more compatible knowledge elements.

16. The method of claim 1, wherein the transfer process includes one or more isolation protocols that prevent the one or more compatible knowledge elements from interacting with one or more component elements of the receiving AI agent.

17. The method of claim 1, further comprising using the at least one hardware processor to:
identify one or more high-performing AI agents; and
for each of the one or more high-performing AI agents,
extract one or more knowledge elements from the high-performing AI agent, and
add the one or more knowledge elements to the knowledge repository.

18. The method of claim 17, further comprising using the at least one hardware processor to, for each of the one or more high-performing AI agents, for each of the one or more knowledge elements extracted from the high-performing AI agent:
classify the knowledge element into a classification in each of a plurality of dimensions; and
add the classifications in the plurality of dimensions to metadata associated with the knowledge element within the knowledge repository.

19. A system comprising:
at least one hardware processor; and
software that is configured to, when executed by the at least one hardware processor, perform the method of claim 1.

20. A non-transitory computer-readable medium having instructions stored therein, wherein the instructions, when executed by a processor, cause the processor to perform the method of claim 1.
